(19) United States
(12) Patent Application Publication
(10) Pub. No.: US 2008/0198727 A1
(43) Pub. Date: Aug. 21, 2008

(54) Optical Pickup Unit for a Desk Drive and Disk Drive Comprising Such an Optical Pick up Unit

(75) Inventor: Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,687

(22) PCT Filed: May 1, 2006
(86) PCT No.: PCT/IB06/51353

§ 371 Date: Nov. 7, 2007

(30) Foreign Application Priority Data
May 10, 2005 (EP) 05103875.0

(51) Int. Cl. G11B 7/00

(52) U.S. Cl. 369/112.23

(57) ABSTRACT

An optical pickup unit for an optical disk drive, comprises a lens holder (27) including a lens having an optical axis, suspension wire members (33-36) suspend the lens holder (27) in a support frame in a cantilever fashion. The wire members constrain movement of the lens holder relative to the support frame, but allowing at least a translation in a focussing or axial direction (z), parallel to the optical axis of a lens in the lens holder (27). The wire members are fixed to the lens holder in positions at a distance from each other at least in focussing and tracking directions (z, x). The wire members are bent around an axis parallel to the radial direction (x) so as to allow an at least limited rotation about an axis in a tracking or radial direction (x) as well. In this way, an active alpha tilt correction is made possible with simple means.

The invention relates to an optical pickup unit for a disk drive comprising a lens holder including a lens having an optical axis, a support frame, and suspension members for suspending the lens holder in the support frame in a cantilever fashion, i.e. in a balcony-like way, which suspension members constrain movement of the lens holder relative to the support frame, but allowing at least a translation in a focussing direction, parallel to the optical axis of a lens in the lens holder. An actuator is provided to give rise to a force between the lens holder and the support frame to cause said translation.

The invention further relates to an optical disk drive comprising such an optical pickup unit and a means for supporting and rotating an optical disc.

An example of an optical pickup unit of the type mentioned in the opening paragraph is known in practice. In common optical pickup units in for example CD, DVD and blue ray disk drives, the lens holder is adapted to make limited translations in tracking and focusing directions, and a limited rotation about an axis in tangent direction. However, such movements do not suffices in the sophisticated application, such as the blue ray disk drive and near field drives. In these applications, it is preferred to enable the lens to also make a rotation about a radial axis, the so-called α tilt. This α tilt correction should be continuous to enable the actuator to correct the lens tilt dependent on the actual situation.

One example of the prior art optical pickup unit in which it is attempted to provide a continuous α tilt correction is disclosed in U.S. Pat. No. 6,134,058 A. In this prior art structure, the suspension members comprise four parallel suspension wires which are fixed on one end to the lens holder and at their other end to elastically deformable elements, which allow the suspension wires to make a certain movement thereby allowing the lens holder to make an α tilt rotation. However, this solution is not only a complicated one, but it is also questionable whether such suspension will work, as it will require also limited movement between the wire members and the lens holder which appears not to be enabled.

An object of the present invention is to improve the prior art optical pick up units and to provide a simple and effective means to allow the lens to rotate around an axis oriented substantially perpendicular to the optical axis, in particular a radial axis.

This object is achieved by the optical pickup unit according to the invention in which the suspension members are shaped so as to allow an at least limited rotation about an axis in radial direction, and in which the actuator is adapted to give rise to a force between the lens holder and the support frame to cause said rotation.

According to the invention, the shape of the suspension members is designed such that it will allow at least limited rotation about an axis in radial direction. This is a relatively simple feature but with the proper design it can be very effective.

An advantageous embodiment of this suspension members is defined in claim 2. According to this embodiment, common wire members may be used, which are bent around an axis parallel to the radial direction. This bend will act as means to provide the freedom of movement, such that the bend will be enlarged or reduced upon rotation of the lens holder.

In the embodiment of claim 3, the shape of the wire members can be very simple, for example as is defined in claim 4.

According to the embodiment of claim 5, the additional movements of the lens holder caused by deformation of the wire members is minimal, so that actuation of the lens holder movements can be further improved and be very actuate.

In the embodiment of claim 6, a compact arrangement is obtained, while the wire members will not interfere or contact during the movements of the lens holder.

In the preferred embodiment of claim 9, use can be made of the coils and corresponding magnetic circuit, which are already provided for the focusing movements of the lens holder.

The invention will now be explained in further detail with reference to the accompanying figures, in which:

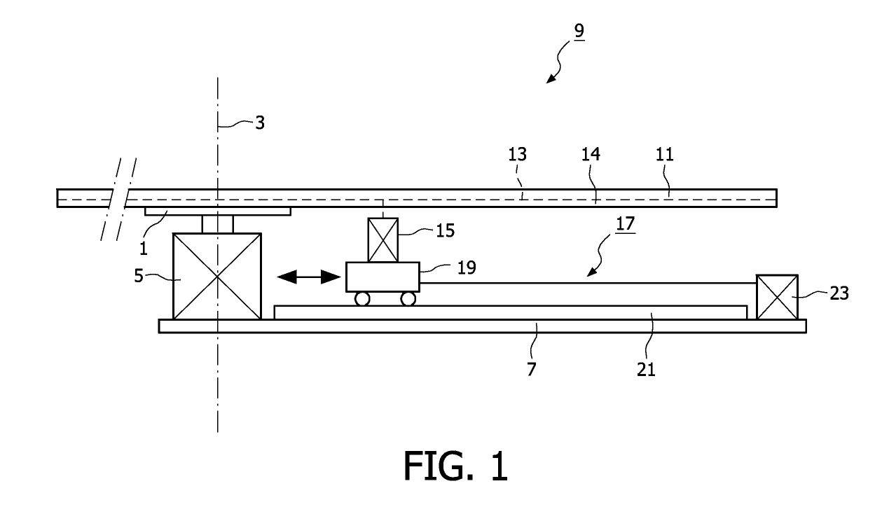

FIG. 1 is a very schematic diagram of an optical disk drive;

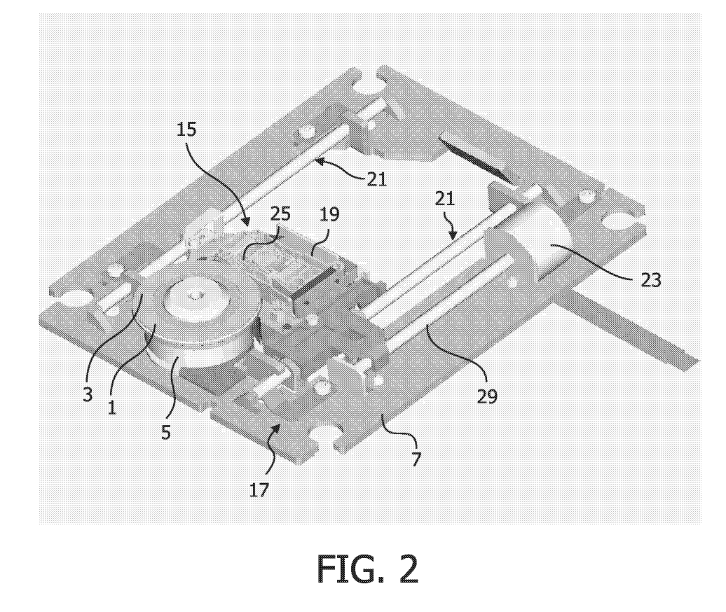

FIG. 2 is a perspective view of an embodiment of the optical disk drive according to the invention;

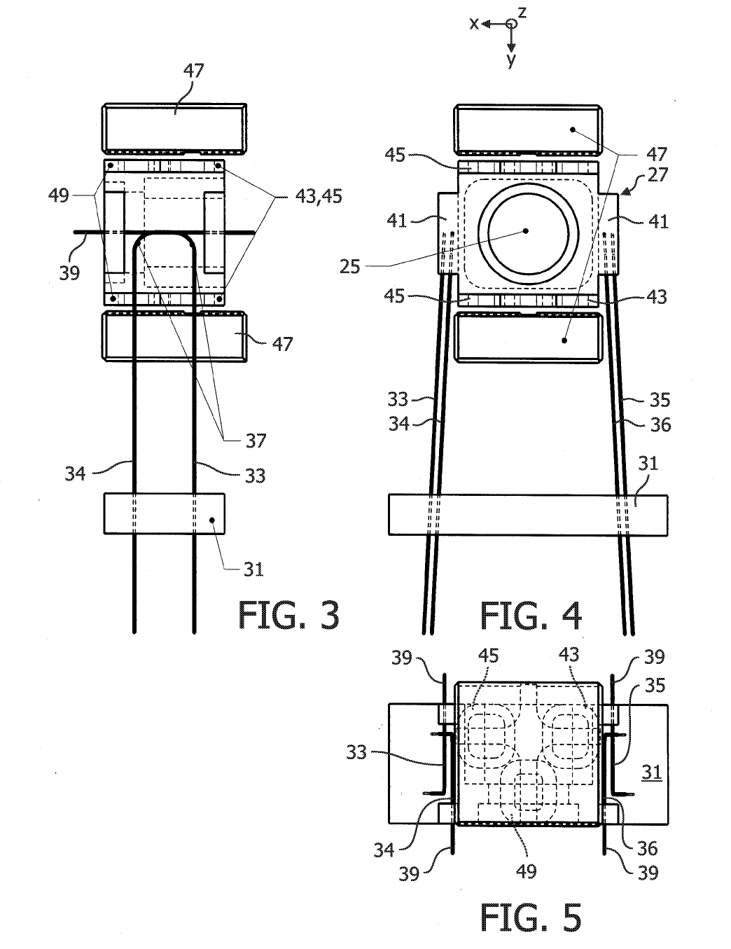

FIG. 3, 4 and 5 are a side view, a plan view and a front view (European projection), respectively, of an embodiment of the optical pickup unit according to the invention.

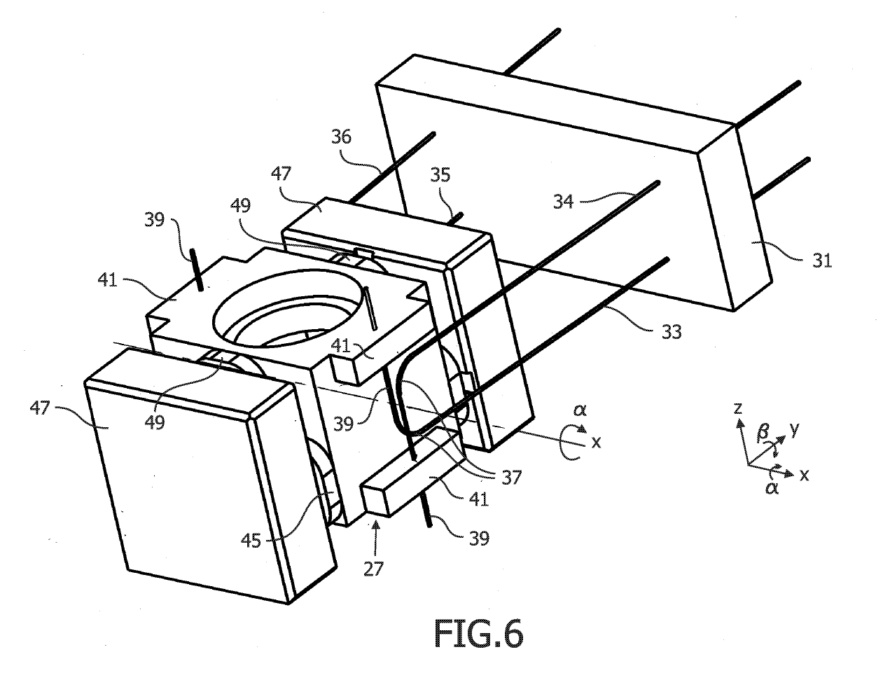

FIG. 6 is a perspective view of the pickup unit of FIGS. 3-5, on a larger scale

FIG. 1 diagrammatically shows an optical disk drive in accordance with the invention, which comprises a turntable 1, which can be rotated about an axis of rotation 3 and driven by an electric motor 5, which is secured on a frame 7. An optically scannable information carrier or disk 9, such as a CD, DVD or Blue ray disk, can be placed on the turntable 1, which disk is provided with a disk-shaped substrate 11 on which an information layer 13 having a spiral-shaped information track is present. The information layer 13 is covered with a transparent protective layer 14.

The optical player further comprises an optical pickup unit 15 in accordance with the invention for optically scanning the information track present on the information layer 13 of the disk 9. The optical pickup unit 15 can be displaced with respect to the axis of rotation 3 mainly in two opposite radial or tracking directions x and x′ by means of a sledge mechanism 17 of the optical player. For this purpose, the optical pickup unit 15 is secured to a sledge 19 of the sledge mechanism 17, and the sledge mechanism 17 is further provided with a straight guide 21 provided on the frame 7 and extending parallel to the x direction, over which guide 21 the sledge 19 is displaceably guided, and with an electric motor 23 by means of which the sledge 19 can be displaced over the guide 21.

In operation, an electrical control unit of the optical player, which is not shown in FIG. 1, controls the motors 5 and 23 so as to cause the disk 9 to rotate about the axis of rotation 3 and, simultaneously, the optical pickup unit 15 to be displaced parallel to the x-direction, in such a manner that the spiral-shaped information track present on the information layer 13 of the disk 9 is scanned by the optical pickup unit 15. During scanning, the information present on the information track can be read by the optical pickup unit 15, or information can be written on the information track by the optical pickup unit 15.

The disk 9 is read by detection of light reflected in the disk 9. For example, a light beam is reflected in the direction of the disk 9 by means of a mirror, which is part of the optical pickup unit 15. If the optical pickup unit 15 is also suited for writing information on the disk, the light beam will have a different power level and/or wavelength during writing, but must also be focussed onto a point in the disk 9, as is the case when the disk 9 is being read. Light reflected by the mirror is focussed onto the disk 9 by means of an objective lens 25, situated in a lens holder 27 and having an optical axis (25

a) (see FIGS. 3-6). The lens holder 27 can make small movements with respect to the sledge 19 by means of an actuator which will be described later on.

As is shown in FIG. 2, the position of the optical pickup unit 6 as a whole in the radial direction of the disk 9 is controlled by means of a lead screw 29 acting on the sledge, and driven by the motor 23. The guide 21 is shown as being formed by straight shafts. The guide and sledge mechanism will not be described further, as they do not form part of the invention.

In a typical optical disk system, the information tracks 2 are very closely spaced in the radial direction, in order to fit as much information as possible onto the disk 9. In a Compact Disk (CD) the distance is 1.6 μm, in a Digital Versatile Disk (DVD) the distance is 0,74 μm. There is a tendency towards smaller track distances in newer systems, as sources of (laser) light of smaller wavelengths and objective lenses 25, or lens systems, with a higher numerical aperture become available. In operation, the light beam of the lens 27 is aligned in a radial direction relative to the disk 9. The position and orientation of the mirror and objective lens 25 determine the point on the disk 9 at which the light is focussed. Smaller distances between successive information tracks in the information layer 13 are made possible by more accurate actuator arrangements for controlling the position and orientation of the optical pickup unit 15.

The lens holder 27 is suspended in the support frame (a support frame part 31 is shown) in such a way that its movement relative to the support frame is constrained. Referring to FIG. 6, the lens holder 27 is firstly able to carry out translations in a focussing direction z. That is, it can be moved closer or further away from the disk 9. In this way, the exact point in the disk 9 on which the light is focussed can be adjusted. Secondly, the lens holder 27 is able to carry out translations in a tracking direction y. By varying the position of the lens holder 27 in the tracking direction, the position on which the light beam 4 is focussed can be moved further or closer to the centre of the disk 9. Thirdly, the lens holder 27 can be tilted, i.e. it can carry out rotations about a tangent direction y (β tilt). In this way, the light beam can be focussed on the disk 9 in such a way that it is always locally perpendicular to the surface of the disk, despite inclination of the disk. Fourthly, the lens holder can be tilted, i.e. it can carry out rotations about a radial direction x (α tilt). In this way the optimum α angle between light beam from the lens and the disk can be maintained.

The adjustment of position and orientation of the lens holder 27 is used to adjust for small geometric deviations in the disk 9, or in the information track. In particular, deviations from a perfect plane—an “umbrella-like” shape—can be compensated for, by varying the degree of tilt and the position in the focussing direction. The possibility of translating the lens holder 27 in the tracking direction y, makes it possible to compensate for deviations from a spiral or circular shape of the information track. This becomes more important as a lens 25 with a higher numerical aperture is used. Such a lens can be positioned closer to the disk, and makes it possible to read a disk 9 with narrow and closely spaced information tracks.

As is shown in FIGS. 3-6, the preferred means by which the lens holder 27 is suspended in the support frame of the optical pickup unit 15, is formed by four wire members 33-36. Each is fixed at one end to the lens holder 27, and to the support frame part 31, i.e. a connecting block, at the other end. The wires 33-36 are fixed to the lens holder in positions at a distance from each other at least in focussing and tracking directions z, x, and at a distance from the plane through the centre of mass and perpendicular to the focussing direction z.

The wire members 33-36 support the lens holder 27 in a cantilever fashion, i.e. the lens holder 27 is suspended to one side only. Two wire members 33, 34 and 35, 36 are provided on each side of the lens holder in radial direction. The wire members 33, 34 and 35, 36 of one side extend parallel to each other, but are offset slightly in radial direction x. The wire member pairs 33, 34 and 35, 36 diverge slightly in a direction away from the lens holder 27. The wire members 33-36 are made of a resilient material, preferably electrically conductive, e.g. copper, iron, or an alloy.

The wire members 33-36 limit the number of degrees of freedom of the lens holder 27. Only translations in the tracking direction x and the focussing direction z are possible. Tilt about the tangent direction y is allowed. However, according to the invention, also tilt about the radial or tracking direction x is made possible.

To enable this, each wire member 33-36 has a special shape, i.e. in this embodiment is bent in at least one position to form a bend 37. In the embodiment shown, the wire members are bent 90° such that the wires 33, 34 and 35, 36 on one side of the lens holder are bent towards each other. However, as the wire members 33, 34 and 35, 36 on each side are slightly offset, they cross each other at a small distance. Due to the bends 37, there are formed perpendicular wire members portions 39. These wire member portions 39 extend substantially within a plane, which extends through the centre of mass of the lens holder and perpendicular to the tangent direction y. The wire member portions 39 are fixed in projections 41 of the lens holder 27 which extend below and above the wire members 33-36.

Due to this shape of the wire members 33-36, the lens holder 27 is able to rotate around an axis in radial or tracking direction x. Upon such rotation, the wire members 33-36 will bend at the position of their respective bend 37, thereby either reducing or enlarging the angle between the wire members portions 39 and the remainder of the respective wire members 33-36. Due to the position of the bends 37 close to the centre of mass of the lens holder 27 a rotation of the lens holder will hardly provoke a translation thereof which should be compensated.

To accurately control the position and orientation, the optical pickup unit 15 comprises an actuator arrangement and a control circuit (not shown). The control circuit provides the driving signals for the actuator arrangement. It is not considered part of the invention and a multitude of possible implementations of a control circuit for this purpose are known, so that no further description is given of the control circuit.

As shown in FIGS. 3-6, the actuator comprises a first focussing coil 43 and a second focussing coil 45 on each opposite side of a plane through the centre of mass of the lens holder 27 and parallel to the focussing direction z and tangent direction y. The winding axis of each coil is perpendicular to the focussing direction z. The focussing coils 43, 45 are fixed to the lens holder 27. A magnetic circuit 47 is provided for each of the focussing coils 43, 45. This magnetic circuit 47 comprises, opposite to each pair of focussing coils 43, 45, a yoke and permanent magnets. These magnets, viewed in a direction parallel to the focussing direction z, are arranged next to each other on the closing yoke manufactured from a magnetizable material. The permanent magnets have respectively, a direction of magnetization M directed parallel to the tangent direction y, and a direction of magnetization M′ directed parallel to the tangent direction y, but opposite thereto. Of course, a yoke and electromagnets could also be used, in principle.

The same magnetic circuit 47 is also used for the actuator arrangement used to control movement in the tracking direction x. The magnetic circuit forms a loop in a plane parallel to the tracking direction x and the tangential direction y. The flux is therefore also parallel to the tangential direction y at a point in the circuit.

The air gaps also provides space for accommodating radial coils 49, which are mounted in the air gap in each magnetic circuit, with their winding axis aligned in the tangential direction y. The radial coils 49 and the magnetic circuit form an actuating arrangement for controlling the position of the lens holder 27 in the tracking direction x. Instead of using only one radial coil 49, it would also be possible to use two.

A current flowing through one of the focussing coils 43, 45 will give rise to a force in the focussing direction z. Turning to FIGS. 3-5, it will be more clearly appreciated that the first and second focussing coils 43, 45 are positioned on opposite sides of a plane through the centre of mass of the lens holder 27 and parallel to the focussing direction z and tangent direction y. Due to this positioning, an imbalance between the forces generated when the first and second focussing coils 43, 45 are driven, will result in a tilting action of the lens holder 27 about an axis parallel to the tangent direction y. A current flowing through the focussing coils 43, 45 on one side and a counter current flowing through the focussing coils 43, 45 on the opposite side will result in a force urging the lens holder 27 to rotate about an axis parallel to the radial direction x (α tilt). Thus, only the control circuit and not the actuator arrangement has to be adapted to enable the lens holder 27 to tilt in α direction.

The wire members 33-36 are preferably electrically conductive to be able to use them for supplying driving currents to the radial coils 49 and the first and second focussing coils 43, 45. Four wire members 33-36 are exactly sufficient for providing the required driving currents. The control circuit (not shown) provides three control signals to the actuator arrangement. A radial coil control signal determines movement in the tracking direction x, wherein the direction of the driving current determines whether this movement is towards or away from the centre of the disk 9. A focus control signal controls the focussing of the beam by the objective lens 25, through the position of the lens holder 27 in the focussing direction z. A β control signal controls the degree and direction of β tilt of the lens holder 27. The β tilt control signal is added to the focus control signal for the first focussing coil 43, and subtracted for the second 45, to obtain the driving current. Thus, the first and second focussing coil 43, 45 are provided with different driving currents to enable tilt. The α tilt control signal controls the degree and direction of a tilt of the lens holder. The α tilt control signal is added to the first and second focussing coils on one side of the lens holder and subtracted for the first and second focussing coils on the opposite side thereof. The radial coils 49 are all provided with the same driving current. They are therefore connected in series. One of the conductive wire members 33-36 is a common wire, to which the series connected radial coils 49 and each of the focussing coils 43, 45 are connected at one end. Current to the radial coils 49 is supplied through a second wire member 35. Current to the first and second focussing coils 43, 45 is supplied through a third and fourth wire member 34, 36.

Preferably, the wire members 33-36 are provided with a cladding of elastic, preferably electrically insulating material. Apart from the insulation, the function of the cladding is to dampen any parasitic oscillations of the lens holder 27, which, as mentioned, forms a spring-mass system with the wire member. Thus, more accurate positioning is achieved.

From the foregoing description, it will be clear that the invention enables an active α tilt correction with simple means, i.e. shaping the suspension members so as to enable this tilt movement and adapting the actuator to generate the α tilt control forces.

The invention is not limited to the above-described embodiments, which may be varied within the scope of the claims. For example, it is not strictly necessary that the lens holder be suspended by rod-shaped wire members. Blades, shaped to form hinges could also be used, but would be much stiffer, thus requiring a larger force to tilt the lens holder. The bends in the wire members could be formed in other positions, for example near the support frame part, but additional movements will be introduced during tilting which should be compensated. Further, although a single objective lens 25 is used in the described embodiment, the lens holder may comprise a more elaborate optical system for focussing and/or splitting the beam, depending on the complexity of the optical drive.

In the presently preferred embodiments, the disk is an optical disk. However, it should be understood that the invention can also be used for all kinds of other disks e.g. ferro-electric, magnetic, magneto-optic, near-field, active charge storage disks or other disks using combinations of these techniques or other reading and/or writing techniques. In these cases the lens and laser will be replaced by another reading/writing member which may require cooling.

In general it is noted that, in this application, the expression “comprising” does not exclude other elements, and “a” or “an” does not exclude a plurality. A single processor or unit may fulfil the functions of several elements in the appended claims. Reference signs in the claims shall not be construed as limiting the scope thereof.

1. Optical pickup unit for an optical disk drive, comprising:
a lens holder (27) including a lens (25) having an optical axis (25a),
a support frame (31),
suspension members (33-36) for suspending the lens holder (27) in the support frame in a cantilever fashion, which suspension members constrain movement of the lens holder relative to the support frame, but allowing at least a translation in a focussing or axial direction (z), parallel to the optical axis of a lens (25) in the lens holder (27), while the suspension members are shaped so as to allow an at least limited rotation about an axis in a tracking or radial direction (x) as well, and
an actuator (43-49) adapted to give rise to a force between the lens holder (27) and the support frame (31) to cause said translation and/or rotation.

2. Optical pickup unit according to claim 1, wherein the suspension members (33-36) comprise wire members, each fixed at one end to the lens holder (27) and at the other end to the support frame (31) so as to provide the cantilever suspension, said wires being fixed to the lens holder in positions at a distance from each other at least in focussing and tracking directions (z, x), said wires being bent around an axis parallel to the radial direction (x).

3. Optical pickup unit according to claim 2, wherein the wire members (33-36) are bent at substantially the same position in tangent direction (y).

4. Optical pickup unit according to claim 3, wherein the wire members (33-36) are bent through substantially 90°.

5. Optical pickup unit according to claim 4, wherein the wire members (33-36) are bent near a plane through the centre of mass of the lens holder (27) and perpendicular to the tangent direction (y).

6. Optical pickup unit according to claim 2, wherein the wire members (33-36) are positioned such that two wire members (33, 34 and 35, 36) extend on each side of the lens holder (27), the wire members which are positioned on the same side of the lens holder cross each other, preferably at a small distance from each other.

7. Optical pickup unit according to claim 6, wherein the wire members (33-36) are bent through 90° thereby creating substantially perpendicular wire member portions (39), said wire member portions extending in a plane perpendicular to the tangent direction (y).

8. Optical pickup unit according to claim 6, wherein the wire members (33-36) extend substantially parallel to each other, the wire members 33, 34 and 35, 36) on the same side of the lens holder (27) being offset in radial direction (x).

9. Optical pickup unit according to claim 1, wherein the actuator comprises coils (43, 45, 49), each positioned relative to a magnetic circuit (47), the coils of the actuator comprise at least two conductive focussing coils (43, 45) on opposite sides of the lens holder (27), the focussing coils being positioned relative to a fixed magnetic circuit (47) and being integrated in a control circuit in such a way that equal currents flowing through the coils (43, 45) on opposite sides give rise to a force between the lens holder (27) and the support frame (31) in the focussing direction (z), and that counter currents flowing through the coils (43, 45) on opposite sides give rise to a force between the lens holder (27) and the support frame in the direction of rotation about the axis parallel to the radial direction (x).

10. Optical pickup unit according to claim 1, wherein the wire members (33-36) are of an electrically conducting material and electrically connected to the coils (43, 45, 49), and wherein the wire members are provided with a cladding of elastic material.

11. Optical pickup unit according to claim 1, wherein the suspension members are adapted to also allow an at least limited translation in a tracking or radial direction (x), perpendicular to the focussing direction (z), and an at least limited rotation about an axis in a tangent direction (y).

12. Optical disk drive comprising an optical pickup unit (15) according to claim 1 and further comprising a means for supporting and rotating an optical disk.
